(19) United States
(12) Patent Application Publication
(10) Pub. No.: US 2018/0296950 A1
(43) Pub. Date: Oct. 18, 2018

(54) SYSTEM FOR REMOVING AND COLLECTING FINELY CUT CHIPS

(71) Applicant: SAMHEUNG PRECISION CO. LTD., Changwon (KR)

(72) Inventor: Jae Yeol YANG, Changwon (KR)

(21) Appl. No.: 15/650,640

(22) Filed: Jul. 14, 2017

(30) Foreign Application Priority Data
Apr. 14, 2017 (KR) 10-2017-0048278

(51) Int. Cl. B01D 33/00; B23Q 11/00; B23Q 11/10; C22B 1/00

(52) U.S. Cl. CPC B01D 33/0058; B01D 33/0006; C22B 1/005; B23Q 11/1069; B23Q 11/0067; B23Q 11/0075

(57) ABSTRACT

Disclosed is a system for removing and collecting finely cut chips. The system can scrape and collect cutting oil and finely cut chips accumulated under a cutting apparatus using a scraper moving in a predetermined direction, separately discharge and reuse only cutting oil using a holed plate having holes smaller than finely cut chips, and separately collect and handle only the finely cut chips collected by the scraper.

### CROSS REFERENCE TO RELATED APPLICATION

The present application claims priority to Korean Patent Application No. 10-2017-0048278, filed on Apr. 14, 2017, the entire contents of which is incorporated herein for all purposes by this reference.

### BACKGROUND OF THE INVENTION

### Field of the Invention

The present invention relates to a system for removing and collecting finely cut chips.

### Description of the Related Art

In general, metal machining apparatuses generate cutting chips in various sizes as byproducts through a cutting process. When the cut chips are large or long, there is no problem with removing and collecting the cut chips, but finely cut chips are accumulated under the metal machining apparatuses (or cutting apparatuses) and interfere with normal discharge of cutting oil. Further, finely cut chips and high-viscosity cutting oil stick together, so they block the passage for discharging cutting oil, which interferes with normal operation and causes malfunction of metal machining apparatuses.

Accordingly, in the related art, when a passage for discharging cutting oil was clogged, an operator had to manually remove finely cut chips and cutting oil after stopping the metal machining apparatus. Further, when removal of the chips is neglected, cutting oil flows back or the parts for discharging cutting chips in a metal machining apparatus are damaged

Therefore, the inventor(s), in order to solve the problems with the method of removing cutting chips and the limits in removing and collecting finely cut chips, has invented a system for removing and collecting finely cut chips, the system being able to scrape and collect cutting oil and finely cut chips stacked under a cutting apparatus using a scraper moving in a predetermined direction, separately discharge and reuse only cutting oil using a holed plate having holes smaller than finely cut chips, and separately collect and handle only the finely cut chips scraped and collected by the scraper.

The foregoing is intended merely to aid in the understanding of the background of the present invention, and is not intended to mean that the present invention falls within the purview of the related art that is already known to those skilled in the art.

### SUMMARY OF THE INVENTION

The present invention has been made in an effort to solve the problems and an object of the present invention is to provide a system for removing and collecting finely cut chips, the system being able to scrape and collect cutting oil and finely cut chips accumulated under a cutting apparatus using a scraper moving in a predetermined direction, separately discharge and reuse only cutting oil using a holed plate having holes smaller than finely cut chips, and separately collect and handle only the finely cut chips scraped and collected by the scraper.

A system for removing and collecting finely cut chips according to an embodiment of the present invention may include: a conveyer rotating in a predetermined direction under a cutting apparatus and having a scraper assembly for collecting cutting oil and cut chips generated by the cutting apparatus; a cutting oil collector for collecting the cutting oil after the cut chips and the cutting oil collected and moved in a predetermined direction by the scraper assembly are filtered; a cut chip collector for collecting the cut chips moved to an end of the conveyer; and a cutting oil feeder for feeding the cutting oil collected in the cutting oil collector to the cutting apparatus.

The scraper assembly may scrape and collect the cutting oil and the cut chips accumulated under the conveyer while moving in a predetermined direction corresponding to the rotation of the conveyer.

The conveyer may include: a pair of conveyer chains rotating in a predetermined direction under the cutting apparatus; a pair of rotary rollers rotating the pair of conveyer chains in the predetermined direction; a pair of link plates fixing the scraper assembly between the pair of conveyer chains; and a tension plate maintaining tension at a predetermined level in a longitudinal direction of the pair of conveyer chains by supporting bottoms of the pair of conveyer chains. The scraper assembly may protrude outward from the pair of conveyer chains.

A first end may be positioned higher than a second end in the pair of conveyer chains.

The scraper assembly may include: a support plate connected between the pair of link plates; and an elastic scraper connected to the support plate and perpendicularly coming in contact with a bottom of the conveyer on a lower end, and when the pair of conveyer chains rotates, the lower end of the elastic scraper may move and collect the cut chips and cutting oil in contact with the bottom of the conveyer.

The elastic scraper may be coupled to the support plate by one or more bolts to be able to be detachably coupled to the support plate and vertically moved to change the position.

The elastic scraper may be made of stainless steel (SUS) having wear resistance.

The cutting oil collector may include: a holed plate having a plurality of holes smaller than the cut chips and disposed under a portion of the bottom of the conveyer; and a cutting oil collector tank for collecting the cutting oil filtered through the holed plate, in which the cutting oil moved by the scraper assembly may be collected into the cutting oil collector tank through the holed plate, and the cut chips larger than the holes of the holed plate may keep moving to the cut chip collector by the scraper assembly.

The holed plate may be coupled to the bottom of the conveyer by one or more holes to be detachable.

The cutting oil feeder may include a coolant pump for feeding the cutting oil collected in the cutting oil collector tank to the cutting apparatus.

A sub-holed plate having a plurality of holes smaller than the cut chips may be disposed between the cutting oil collector tank and the coolant pump.

The system may further include a ball valve disposed in a pipe connecting the cutting apparatus and the cutting oil collector tank to each other.

The pair of link plates may be bent at centers of edges to correspond to outer sides of the pair of rotary rollers, so when the pair of conveyer chains rotates in a predetermined direction, interference is not be generated between the pair of link plates and the pair of rotary rollers.

According to an aspect of the present invention the system for removing and collecting finely cut chips can scrape and collect cutting oil and finely cut chips accumulated under a cutting apparatus using a scraper moving in a predetermined direction, separately discharge and reuse only cutting oil using a holed plate having holes smaller than finely cut chips, and separately collect and handle only the finely cut chips collected by the scraper. Accordingly, it is possible to prevent a passage for discharging cutting oil from being clogged with finely cut chips.

Further, according to another aspect of the present invention, since an elastic scraper for moving cutting chips and cutting oil in a predetermined direction can be replaced and vertically moved to change the position, maintenance of the system is convenient by replacing only the elastic scraper when the elastic scraper is worn or damaged.

Further, according to another aspect of the present invention, since it is possible to discharge and reuse only cutting oil using a holed plate, the cutting oil can be more efficiently used.

Further, according to another aspect of the present invention, since finely cut chips and cutting oil can be separately collected, it is possible to prevent finely cut chips and cutting oil from sticking to each other in a collector tank.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view showing the entire configuration of a system 100 for removing and collecting finely cut chips according to an embodiment of the present invention;

FIG. 2 is a view showing in detail the configuration of a conveyer 110 shown in FIG. 1;

FIGS. 3A and 3B are views showing in detail the configuration of scraper assembly 110c shown in FIG. 2; and

FIGS. 4A and 4B are views showing in detail the configuration of a cutting oil collector 120 and a cutting oil feeder 140 shown in FIG. 1.

### DETAILED DESCRIPTION OF THE INVENTION

Hereinbelow, exemplary embodiments of the present invention will be described in detail with reference to the accompanying drawings. Throughout the drawings, the same reference numerals will refer to the same or like parts.

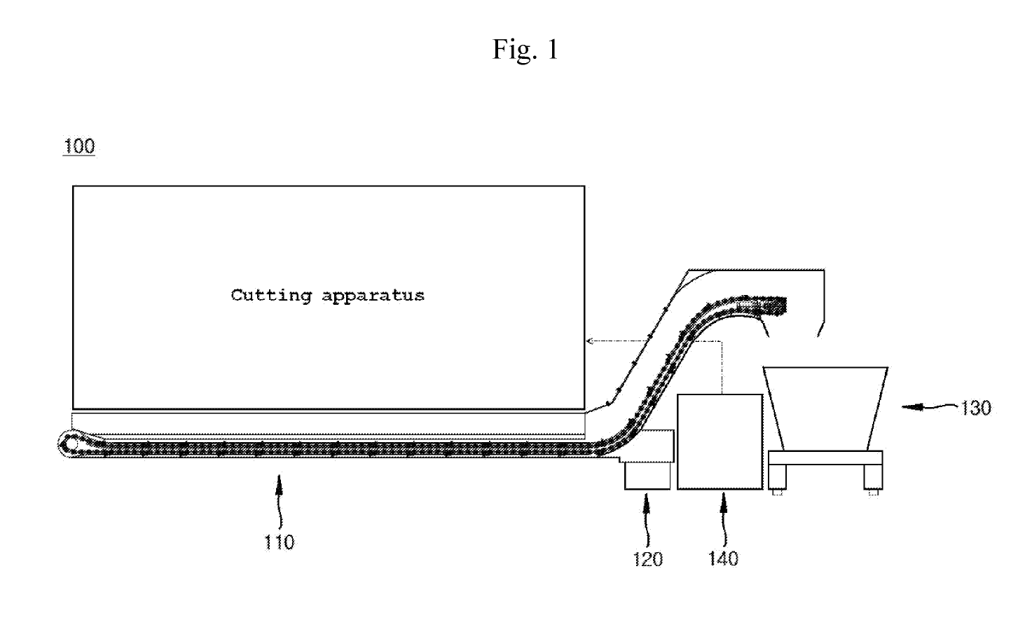

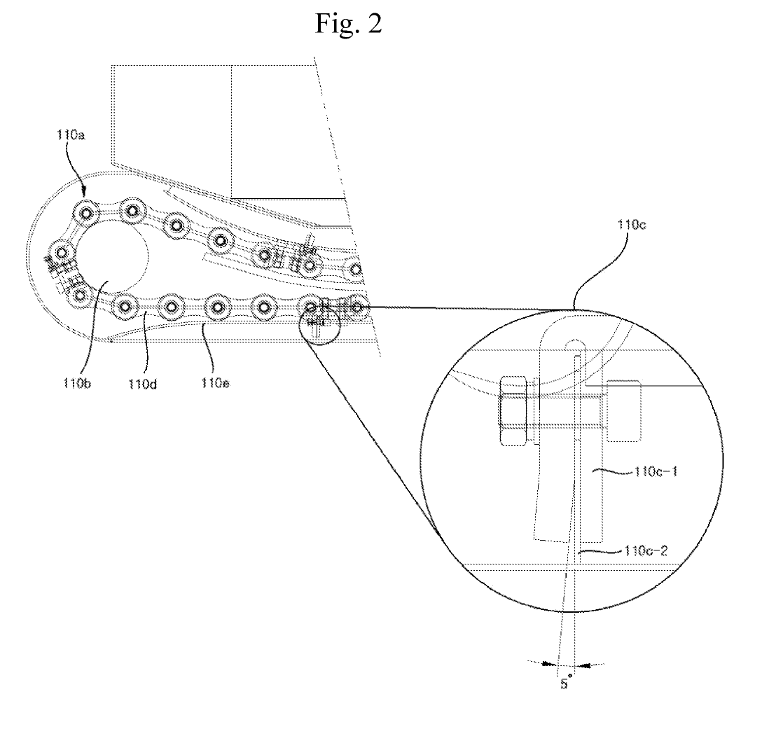

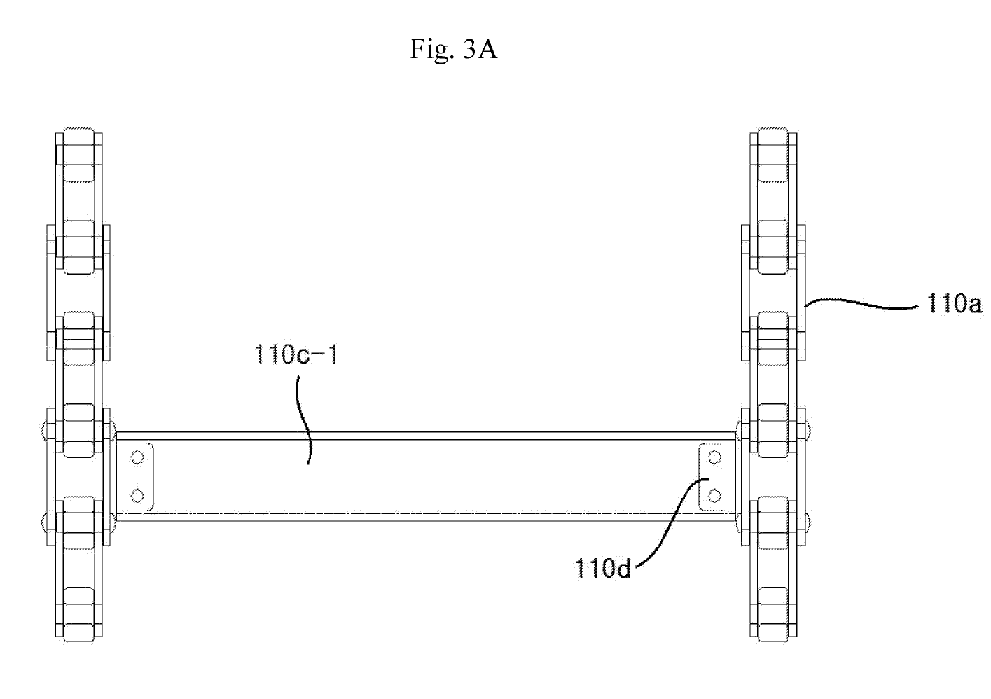

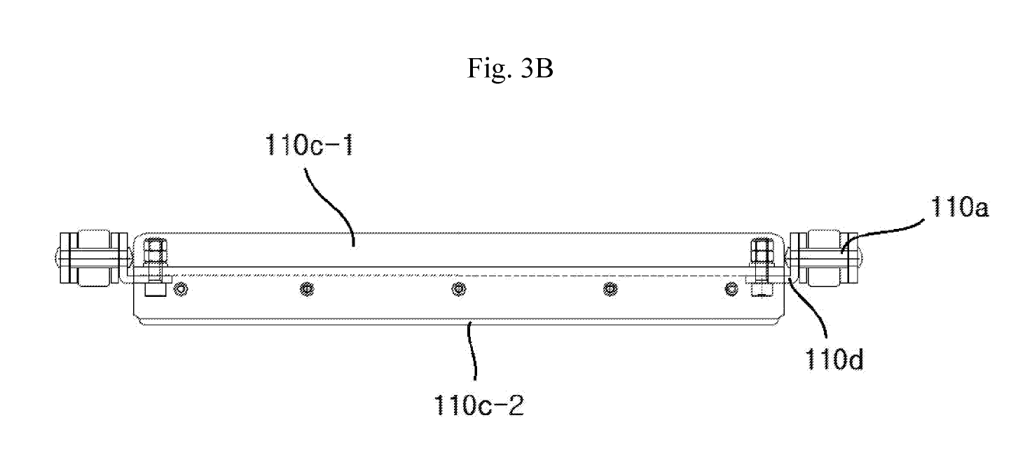

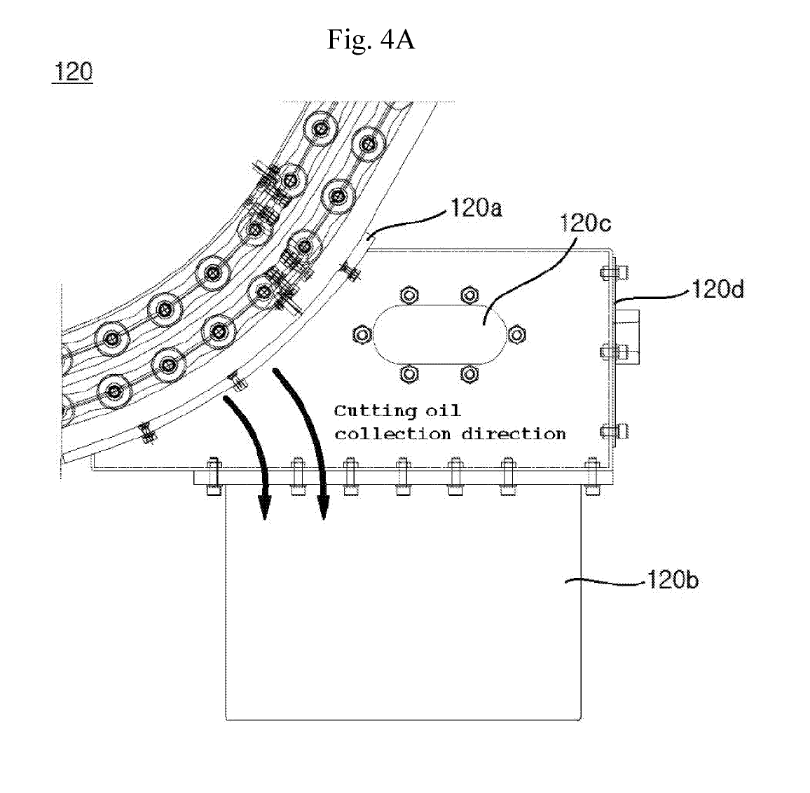

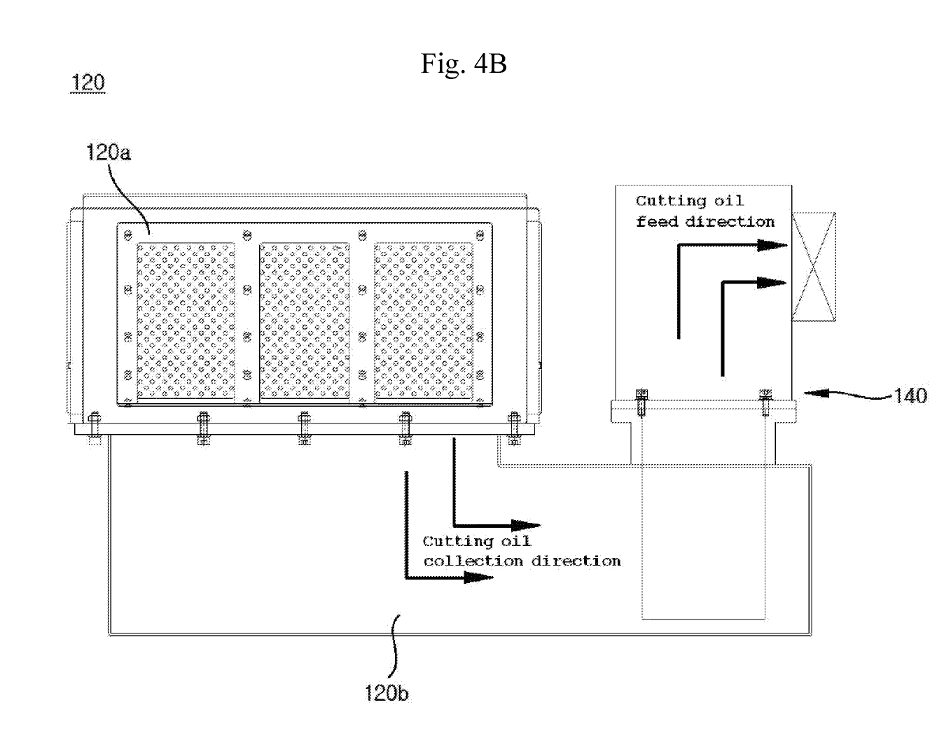

Referring to FIGS. 1 to 4, a system 100 for removing and collecting finely cut chips according to an embodiment of the present invention may include in a broad sense a conveyer 110, a cutting oil collector 120, a cut chip collector 130, and a cutting oil feeder 140.

First, the conveyer 110 can collect cutting oil and cut chips that are generated and accumulated by a cutting apparatus for machining (or cutting) metal (for example, a cutting facility, cutting equipment, a metal cutting apparatus, or a metal machining facility) by rotating in a predetermined direction under the cutting apparatus.

The cut chips that are accumulated may mean finely cut chips that are byproducts in machining of metal and are smaller than cut chips generated in normal cutting, and the cutting oil may be cooling liquid that is provided for lubrication, rust resistance, and cooling in cutting.

When finely cut chips and cutting oil have stuck together for a long time, the passage for discharging the cutting oil may be clogged. Therefore, according to the present invention, finely cut chips and cutting oil stacked under the conveyer 110 are moved to the cutting oil collector 120 and the cutting chip collector 130, which will be described below, by the conveyer 110 in order to quickly and continuously remove the cutting chips and cutting oil.

The conveyer 110 may include: a pair of conveyer chains 110a rotating in a predetermined direction under the cutting apparatus, a pair of rotary rollers 110b rotating the conveyer chains in the direction, a scraper assembly 110c disposed between the conveyer chains and scraping cutting oil and finely cut chips accumulated under the conveyer 110, a pair of link plates 110d fixing the scraper assembly 110c to the conveyer chains 110a, and a tension plate 110e maintaining tension at a predetermined level in the longitudinal direction of the conveyer chains 110a by supporting the bottoms of the conveyer chains 110a.

In the conveyer chains 110a, a first end may be positioned higher than a second end. For example, in the conveyer chains 110a, the portions over the cut chip collector 130 and the cutting oil feeder 140 may be positioned higher than the portions under the cutting apparatus.

Accordingly, the rotary rollers 110b rotate counterclockwise and the conveyer chains 110a also rotate counterclockwise in the figures.

Since the first ends of the conveyer chains 110a are positioned higher than the second ends, cut chips and cutting oil scraped and moved by the scraper assembly 110c can be separately collected.

In particular, a plurality of ball bearings (for example, radial bearings) may be disposed inside the rotary rollers 110b and covers for preventing finely cut chips from flowing inside may be disposed on both sides of the rotary rollers 110b. Accordingly, the rotary roller 110b can rotate under minimum load (or no load) without torque, so rotational efficiency can be maximized.

The link plates 100d may be bent inward at the center of the edge to correspond to the outer sides of the rotary rollers 110b, for example, may be formed in the shape of a peanut with a recessed center. Accordingly, when the conveyer chains 110a are rotated around the rotary rollers 110b in a predetermined direction, interference is not generated between the link plates 110d and the rotary rollers 110b.

If the centers of the edges of the link plates 110d are straight, the centers of the edges of the link plates 110d and the outer sides of the rotary rollers 110b may interfere with each other, so it should be noted the centers of the edges of the link plates 110d are bent inward to prevent the interference in the present invention, as described above.

The link plates 110d may have an L-shape when seen from a side and a support plate 110c-1 of the scraper assembly 110c may be bolted to the lower wall of the L-shape, so bolt holes for bolting the support plate 110c-1 may be formed at the lower wall of the L-shape.

The number of the link plates 110d may be correspond to the number of the scraper assembly 110c, but is not limited.

The scraper assembly 110c may include a support plate 110c-1 connected (bolted) between the link plates and an elastic scraper 110c-2 connected (bolted) to a side of the support plate to perpendicularly come in contact with the bottom of the conveyer 110 on the lower end.

The support plate 110c-1 may have a lower wall that can be bolted to the lower wall of the L-shapes of a pair of link plates 110d and a side wall that can be bolted to the elastic scraper 110c-2.

The support plate 100c-1 can function as a separation wall that prevents substantially the entity of the elastic scraper 110c-1 from bending and forms a space for keeping finely cut chips and cutting oil.

A gap of about 0.5 mm may be formed between the support plate 110c-1 and the bottom of the conveyer 110 for the purpose of maintaining the gap is for preventing interference and friction between support plate 110c-1 and the bottom of the conveyer 110 because the support plate 110c-1 cannot bend unlike the elastic scraper 110c-2.

The elastic scraper 110c-2 can scrape and collect finely cut chips and cutting oil in contact with the bottom of the conveyer 110 when the conveyer chains 110a rotate. That is, the elastic scraper 110c-2 can scrape and collect finely cut chips and cutting oil like the wiper of a vehicle.

The elastic scraper 110c-2 can be bolted to the support plate 110c-1 by one or more bolts, so it can be detachably coupled to the support plate 110c-1 and can be vertically moved to change the position.

Accordingly, when the lower portion of the elastic scraper 110c-2 is worn or damaged, it is possible to loosen the bolts and replace the elastic scraper 110c-2 with a new one or move down the elastic scraper 110c-2 to deal with wear.

Since the elastic scraper 110c-2 scrapes finely cut chips and cutting oil in contact with the bottom of the conveyer 110, it may be made of stainless steel having wear resistance (fore example, SUS304) or it may be made of other elastic metal having wear resistance other than stainless steel.

The lower portion of the elastic scraper 110c-2 can bend in the opposite direction to the moving direction (or forward direction), in which the banding angle may be 5 degrees.

Accordingly, even if the elastic scraper 110c-2 hits against an obstacle while it collects finely cut chips and cutting oil with the lower portion in contact with the bottom of the conveyer 110, it can bend at about 5 degrees, so it is not damaged.

It should be noted that the bending angle of the elastic scraper 110c-2 is not limited and can be freely changed.

The tension plate 110e can be provided to correspond to the entire length of the conveyer 110 and can equilibrate the tension at both ends and the centers of the conveyer chains 110a by supporting the bottoms of the conveyer chains 110a.

Since the conveyer chains 110a are made of metal, the centers may be sagged down by their weight. Since both ends of the conveyer chains 110a are supported by the rotary rollers 110b, there is no problem, but since there is no rotary roller at the centers, the tension plate 110e is provided through the entire length of the conveyer chains 110a in the present invention.

The tension plate 110e may be provided in pairs to support both of the upper and lower lines of the conveyer chains 110a.

It should be noted that the length and shape of the tension plate 110e are not limited as long as the tension plate 110e supports the bottoms of the conveyer chains 110a without a difference in tension at the ends and the centers of the conveyer chains 110a.

Next, the cutting oil collector 120 filters finely cut chips and cutting oil collected and moved by the scraper assembly 110c, in detail, the elastic scraper 110c-2, and then discharges down and collects only the cutting oil.

To this end, the cutting oil collector 120 may be disposed under a portion of the conveyer 110 and may include a holed plate 120a having a plurality of holes smaller than finely cut chips and a cutting oil collector tank 120b for receiving the cutting oil filtered through the holed plate 120a.

The holed plate 120a may be bolted to the conveyer 110, in which flat headed bolts that are not exposed to the outside because the tops are flat may be used.

Accordingly, even if the elastic scraper 110c-2 moves while scraping the top of the holed plate 120a, there is no interference between the flat headed bots and the elastic scraper 110c-2.

Further, since the holed plate 120a is bolted to the conveyer 110, it can be separated, so it is possible to simply maintain the holed plate 120a by loosening the bolts when it is required to replace the holed plate 120a.

When the elastic scraper 110c-2 scrapes and moves with finely cut chips and cutting oil, the cutting oil is discharged into the cutting oil collector tank 120b through the holes of the holed plate 120a, but the finely cut chips do not pass through the holed plate 120a and keep moving with the elastic scraper 110c-2 to the cut chip collector 130.

Since the holes of the holed plate 120a are smaller than the finely cut chips, the finely cut chips can be filtered even though the cutting oil is discharged down through the holes.

The holed plate 120a may be 2 mm thick and an additional plate may be welded to the lower portion of the holed plate 120a. The holed plate 120a may be positioned at the curved portion of the conveyer 110 shown in FIG. 1, for example, at an angle of 45 degrees. When the holed plate 120a is positioned at an angle less than 45 degrees, finely cut chips may be stuck in the holes while cutting oil is discharged, so the holed plate 120a is positioned at 45 degrees so that finely cut chips can be smoothly moved up by the scraper 110c-2 even after the cutting oil is discharged.

On the other hand, the cutting oil received in the cutting oil collector tank 120b can be supplied back to the cutting apparatus through the cutting oil feeder 140.

According to an embodiment of the present invention, a window 120c that allows a user to see the cutting oil discharged (collected) through the holes of the holed plate 120a is disposed on a side (for example, on the left or right side) of the cutting oil collector 120. The window 120c may be made of transparent acryl or transparent glass and it may be made of other transparent materials other than acryl and glass as long as a user can see the inside of the cutting oil collector 120 through it.

The window 120c may be fixed to the cutting oil collector 120 by one or more bolts.

According to another embodiment, a cleaning cover for opening a portion of the cutting oil collector 120 to clean the inside of the cutting oil collector 120 is disposed on a side (for example, on the left, right, or front side) of the cutting oil collector 120, so a user can clean the inside of the cutting oil collector 120 after opening the cleaning cover 120d.

The cleaning cover 120d can be detachably coupled to the cutting oil collector 120 by one or more bolts, or as another embodiment, a hinge may be disposed between the cleaning cover 120d and the cutting oil collector 120 to open/close the cleaning cover 120d in a swing door type.

Next, the cut chip collector 130 can collect finely cut chips moved to an end of the conveyer 110 and has wheels, so it can move cut chips to a disposal place when a predetermined amount of cut chips are collected.

Next, the cutting oil feeder 140 can feed cutting oil collected by the cutting oil collector 130 to the cutting apparatus to reuse to the cutting oil. To this end, the cutting oil feeder 140 may include a pump (for example, a coolant pump) for pumping up the cutting oil collected in the cutting oil collector tank 120b to the cutting apparatus.

In an embodiment, a sub-holed plate (not shown) having a plurality of holes smaller than cutting chips may be disposed between the cutting oil collector tank 120b and the pump (for example, a coolant pump) and can function the same as the holed plate 120a.

In another embodiment, a ball valve (not shown) may be disposed in a pipe (not shown) connecting the cutting apparatus and the cutting oil collector tank 120b, so when the ball valve is opened, the cutting oil in the cutting oil collector tank 120b can be naturally discharged to the cutting apparatus.

As described above, the system 100 for removing and collecting finely cut chips of the present invention scrapes, collects, and moves cutting oil and finely cut chips accumulated under a cutting apparatus using an elastic scraper, and in this process, the cutting oil is discharged and collected first through a holed plate and the remaining finely cut chips are separately moved, discharged, and collected to the cut chip collector by the elastic scraper. Further, the cutting oil collected in the cutting oil collector tank can be fed to the cutting apparatus to be reused by the cutting oil feeder.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A system for removing and collecting finely cut chips, the system comprising:
a conveyer rotating in a predetermined direction under a cutting apparatus and having a scraper assembly for collecting cutting oil and cut chips generated by the cutting apparatus;
a cutting oil collector for collecting the cutting oil after the cut chips and the cutting oil collected and moved in a predetermined direction by the scraper assembly are filtered;
a cut chip collector for collecting the cut chips moved to an end of the conveyer; and
a cutting oil feeder for feeding the cutting oil collected in the cutting oil collector to the cutting apparatus,
wherein the scraper assembly scrapes and collects the cutting oil and the cut chips accumulated under the conveyer while moving in a predetermined direction corresponding to the rotation of the conveyer.

2. The system of claim 1, wherein the conveyer includes:
a pair of conveyer chains rotating in a predetermined direction under the cutting apparatus;
a pair of rotary rollers rotating the pair of conveyer chains in the predetermined direction;
a pair of link plates fixing the scraper assembly between the pair of conveyer chains; and
a tension plate maintaining tension at a predetermined level in a longitudinal direction of the pair of conveyer chains by supporting bottoms of the pair of conveyer chains, and
the scraper assembly protrudes outward from the pair of conveyer chains.

3. The system of claim 2, wherein a first end is positioned higher than a second end in the pair of conveyer chains.

4. The system of claim 2, wherein the scraper assembly includes:
a support plate connected between the pair of link plates; and
an elastic scraper connected to the support plate and perpendicularly coming in contact with a bottom of the conveyer on a lower end, and
when the pair of conveyer chains rotates, the lower end of the elastic scraper moves and collects the cut chips and cutting oil in contact with the bottom of the conveyer.

5. The system of claim 4, wherein the elastic scraper is coupled to the support plate by one or more bolts to be able to be detachably coupled to the support plate and vertically moved to change the position.

6. The system of claim 4, wherein the elastic scraper is made of stainless steel (SUS) having wear resistance.

7. The system of claim 1, wherein the cutting oil collector includes:
a holed plate having a plurality of holes smaller than the cut chips and disposed under a portion of the bottom of the conveyer; and
a cutting oil collector tank for collecting the cutting oil filtered through the holed plate,
wherein the cutting oil moved by the scraper assembly is collected into the cutting oil collector tank through the holed plate, and the cut chips larger than the holes of the holed plate keep moving to the cut chip collector by the scraper assembly.

8. The system of claim 7, wherein the holed plate is coupled to the bottom of the conveyer by one or more holes to be detachable.

9. The system of claim 7, wherein the cutting oil feeder includes a coolant pump for feeding the cutting oil collected in the cutting oil collector tank to the cutting apparatus.

10. The system of claim 9, wherein a sub-holed plate having a plurality of holes smaller than the cut chips is disposed between the cutting oil collector tank and the coolant pump.

11. The system of claim 7, further comprising a ball valve disposed in a pipe connecting the cutting apparatus and the cutting oil collector tank to each other.

12. The system of claim 2, wherein the pair of link plates is bent at centers of edges to correspond to outer sides of the pair of rotary rollers, so when the pair of conveyer chains rotates in a predetermined direction, interference is not generated between the pair of link plates and the pair of rotary rollers.
